(19) United States
(12) Patent Application Publication
(10) Pub. No.: US 2013/0052091 A1
(43) Pub. Date: Feb. 28, 2013

(54) Honeycomb Body Reactor Interface Anchoring

(71) Applicant: James Scott Sutherland, Corning, NY (US)

(72) Inventor: James Scott Sutherland, Corning, NY (US)

(73) Assignee: Corning Incorporated

(21) Appl. No.: 13/696,390

(22) PCT Filed: May 26, 2011
(86) PCT No.: PCT/US11/38021

§ 371 Date: Nov. 6, 2012

Related U.S. Application Data
(60) Provisional application No. 61/350,005, filed on May 31, 2010.

(51) Int. Cl. B01J 19/00; B23P 11/00

(52) U.S. Cl. 422/129; 29/428

(57) ABSTRACT

Methods and devices for attaching fluidic or other interfaces to an extruded honeycomb body reactor are disclosed, the method including providing a mechanical interface to the honeycomb body without encircling the honeycomb body, and mounting a fluidic or other interface to the mechanical interface. Alternatives for the mechanical interface include trenches on opposite sides of the body, one or more trenches on the same side of the body, and blind holes with screw anchors.

This application claims the benefit of priority of U.S. Application Ser. No. 61/350,005 filed May 31, 2010.

### BACKGROUND

The present disclosure relates in general to techniques for mounting fluidic interfaces on honeycomb extrusion substrate reactors, and in particular to mounting techniques where fluidic interfaces are held in place via mechanical features integrated into the substrate.

### SUMMARY

The present disclosure can provide simple, robust in inexpensive mounting and securing of fluid interconnections or other interfaces with reactors of the honeycomb extruded body type.

Some embodiments include devices for attaching fluidic or other interfaces to an extruded honeycomb body reactor are disclosed, the devices including a mechanical interface to the honeycomb body that does not encircling the honeycomb body, and a fluidic or other interface mounted to the mechanical interface. Alternatives for the mechanical interface include trenches on opposite sides of the body, one or more trenches on the same side of the body, and blind holes with screw anchors.

Further embodiments include the methods needed to form the devices and structures disclosed herein are also aspects of the present disclosure, including the basic method of attaching fluidic or other interfaces to an extruded honeycomb body reactor by providing a mechanical interface to the honeycomb body that does not encircle the honeycomb body, and by mounting a fluidic or other interface attached to the mechanical interface. The step of providing a mechanical interface make take the form of (1) machining or otherwise forming trenches on opposing sides of the honeycomb body, (2) machining or otherwise forming one or more trenches on the same side of the honeycomb body, (3) drilling or otherwise forming blind holes blind holes in the honeycomb body and attaching screw anchors in said blind holes, or other appropriate means. The step of mounting a fluidic or other interface attached to the mechanical interface may take the form of compressing an O-ring against a surface on the honeycomb body by means of the mechanical interface.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a an extruded body substrate having a side port and mechanical anchoring features according to one embodiment;

FIG. 2 is a cross section of the extruded body of FIG. 1 in use with an interface clamp;

FIG. 3 is a cross section similar to that of FIG. 2 but showing another embodiment;

FIG. 4 is a cross-sectional view of still another embodiment;

FIG. 5 is a diagrammatic cross-sectional view of certain components of a strength testing set-up for testing strength of a substrate 20 with a notch 30; and

FIG. 6 is graph of strength testing results obtained using the set-up shown in the diagrammatic cross section of FIG. 5.

### DETAILED DESCRIPTION

Reference will now be made in detail to the accompanying drawings which illustrate certain instances of the methods and devices described generally herein. Whenever possible, the same reference numerals will be used throughout the drawings to refer to the same or like parts.

Techniques for fabricating low-cost continuous flow chemical reactors based on honeycomb extrusion technology have been presented previously by the present inventors and/or their colleagues, for example, as disclosed in patent publication No. US20090169445, assigned to the present assignee. Such reactors are formed within extruded bodies that generally have cells or channels extending along a common direction from a first end of the body to second. Passages with significant length and volume and very high surface-to-volume ratios can be formed by the methods disclosed in the above-referenced application, with access to the passages provided through the ends or through the side walls (or both) of the extruded body. The present disclosure provides devices and methods for versatile yet robust fluidic connection to continuous flow reactors or other similar fluidic devices formed within extruded body substrates.

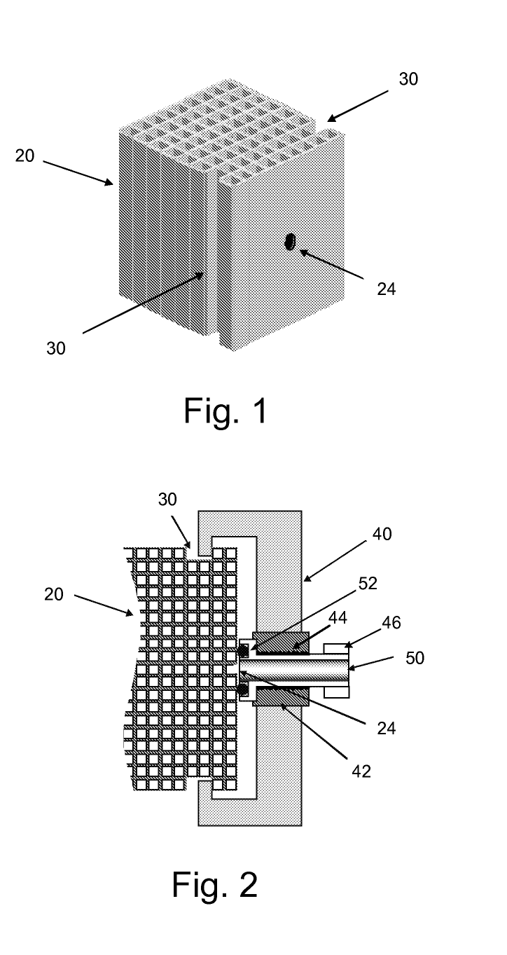

With respect to FIG. 1, according to one embodiment of the present disclosure, a honeycomb body includes a side port 24 and notches or trenches 30 on opposing faces for forming a mechanical interface to the body 20 without encircling the body 20. Trenches 30 or notches provide a mechanical interface or a mechanical engagement or gripping point for the honeycomb body, without the requirement that a structure intended to fix or secure the honeycomb body, or to be fixed to it, must encircle the honeycomb body, as has been the case for some other interfaces (see, e.g., patent publication No. EP2098285, also assigned to the present assignee. By machining or otherwise forming a mechanical interface, a place to grip the extruded body, a fluidic or other interface for interacting with the reactor or other fluidic device may be mounted to the mechanical interfaces. The use of trenches 30 on opposing sides of the honeycomb body, as seen in FIGS. 1 and 2, is one presently preferred type of mechanical interface.

In the case of the embodiment shown in FIGS. 1 and 2, the mechanical interface provided by the opposing trenches 30 allows for a relatively straightforward fluidic interface to the side port 24 in the side of the body 20. This is best seen in the cross section of FIG. 2. An interface clamp 40 is engaged in the trenches 30 as shown. The interface clamp holds a sleeve 42 centered over the side port 24. An O-ring interface 50 is supported within the sleeve. The O-ring interface has a passage therethrough for fluid and desirably some type of standard fluidic coupling at the end away from the body 20. At the end toward the body 120, an O-ring 52 is contained within an O-ring slot or channel and is compressed by the mechanical interface and the O-ring interface 50 against the side of the body 20 around the side port 24. This provides a fluid-tight seal between the passage in the O-ring interface and the passage in the body 20 behind the side port 24. As shown in the figure, the sleeve 42 and the O-ring interface 50 may have a threaded joint or interface 44 between them, and this may be the means of tightening the interface 50 to press against the O-ring 52. The interface 50 may also be provided with a mechanically engageable surface 46 such as a hex head for a wrench or a knurled or otherwise friction-enhanced surface.

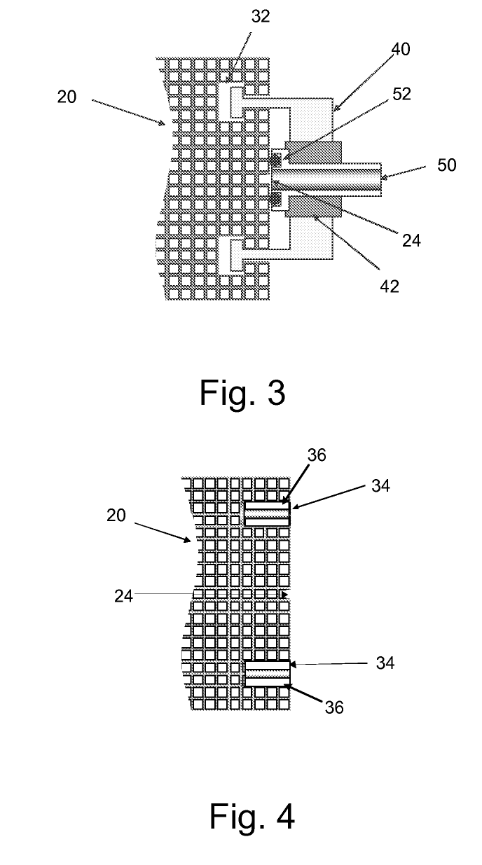

Opposing slots 30 are not the only type of mechanical interface believed to be useful in the context of the present disclosure. With reference to FIG. 3, one or more trenches or channels 32 on a single side of the honeycomb body 20 may also serve as the mechanical interface, particularly if the one or more trenches or channels 32 include at least one, or as in the case of the embodiment shown, two overhanging edges. Then an interface clamp 40 designed to fit the trenches or channels 32 can press against the overhanging edges of the trench(es) 32, as shown in the figure.

Another type of mechanical interface that may desirably be used is shown in the cross-section of FIG. 3. Here, screw anchors 34 are fixed in blind holes 36 that have been drilled or otherwise machined or formed within the honeycomb body 20.

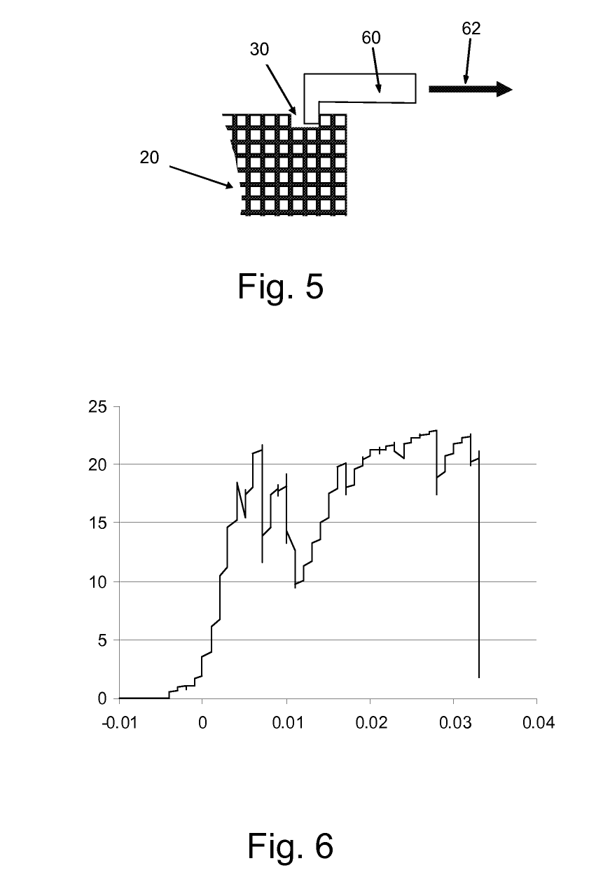

FIG. 5 is a diagrammatic cross-sectional view of certain components of a strength testing rig for testing strength of a substrate 20 with a notch 30 of the type shown in FIGS. 1, 2 (and 5). The O-ring compression force required for leak-free sealing of the 4 mm OD O-rings used in microreaction applications is 50-70 N or 11-15.4 lbs-force. Using a safety factor of 3, the various O-ring interface clamping approaches must resist forces of 150-210 N or 33-46 lbs-force before failing. Note that in all approaches presented above at least two anchoring locations are required. Therefore the peak force before failure can be reduced by a factor of two, resulting in required peak forces of 75-105 N or 16.5-23 lbs-force. If a given approach does not meet this requirement, additional anchoring locations may be added, or the area or length of the anchoring location may be increased. Measurements of peak load prior to breakage were carried out on notched substrates under load as shown in FIG. 5. Two different notch substrate types were evaluated: one support cell and two support cells, where the support cell count refers to the number of substrate cells or that bear the load during notch substrate testing. For example, in FIG. 5 the test substrate has two support cells.

FIG. 6 is a plot of notch sample load (in lbs-force) vs. substrate deflection or extension (in mm) over the course of a peak load test. The notch sample for FIG. 6 had two supporting cells (sample #6). The plot shows a peak load of around 21 lbs-force prior to initial breakage, with possible initial failure around 17 lbs-force.

Table 1 summarizes measurement data for the eight samples. Results show that using two support cells the average peak load before failure is 23.9 lbs-force, while for one support cell the average peak load before failure is 18.8 lbs-force. Therefore using two support cell provides a significant strength advantage over one support cell. Structures with additional support cells are expected to resist higher forces.

The measurements results suggest that using two notch structures on opposite sides of the substrate will meet the target load requirements as long as the at least two support cells are used at each notch. It should also be noted that in the test configuration loading is biased towards the two ends of the notch where load rod deflection is minimized (and where notch strength is less). Thus it appears that strength requirements can very likely be met by mechanical interfaces of the types proposed herein.

TABLE I

| | | Peak load | Peak stress | Strain at break |
|---|---|---|---|---|
| Sample # | Sample type | (lbs-force) | (MPa) | (%) |
| 3 | Two support cells | 24.493 | 238910591.2 | 0.925 |
| 4 | Two support cells | 25.187 | 245677231.0 | 1.017 |
| 5 | Two support cells | 24.718 | 241105538.0 | 3.671 |
| 6 | Two support cells | 21.194 | 206723925.5 | 1.544 |
| 7 | Two support cells | 18.439 | 179856397.9 | 0.606 |
| 8 | Two support cells | 22.897 | 223338315.9 | 0.887 |
| 9 | Two support cells | 17.340 | 169140577.1 | 0.911 |
| 10 | Two support cells | 16.484 | 160782547.0 | 2.121 |

The methods needed to form the devices and structures disclosed herein are also aspects of the present disclosure, including the basic method of attaching fluidic or other interfaces to an extruded honeycomb body reactor by providing a mechanical interface to the honeycomb body that does not encircle the honeycomb body, and by mounting a fluidic or other interface attached to the mechanical interface. The step of providing a mechanical interface make take the form of (1) machining or otherwise forming trenches on opposing sides of the honeycomb body, (2) machining or otherwise forming one or more trenches on the same side of the honeycomb body, (3) drilling or otherwise forming blind holes blind holes in the honeycomb body and attaching screw anchors in said blind holes, or other appropriate means. The step of mounting a fluidic or other interface attached to the mechanical interface may take the form of compressing an O-ring against a surface on the honeycomb body by means of the mechanical interface.

The methods and/or devices disclosed herein are generally useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/ homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

It will be apparent to those skilled in the art that various modifications and variations can be made without departing from the spirit or scope of the invention.

### REFERENCE KEY

20 substrate
24 substrate side port
30 notch
32 channel
34 screw anchor (in a blind hole)
36 blind hole
40 interface clamp
42 sleeve
44 threads
46 nut or rousurface
50 O-ring interface
52 O-ring
60 load applying structure
62 load

1. A method for attaching fluidic or other interfaces to an extruded honeycomb body reactor, the method comprising:
providing a reactor having a honeycomb body;
providing mechanical interface to the honeycomb body, the mechanical interface not encircling the honeycomb body, and
mounting a fluidic or other interface to the mechanical interface.

2. The method according to claim 1 wherein the mechanical interface to the honeycomb body comprises trenches on opposing sides of the honeycomb body.

3. The method according to claim 1 wherein the mechanical interface to the honeycomb body comprises one or more trenches on a single side of the honeycomb body.

4. The method according to claim 1 wherein the mechanical interface to the honeycomb body comprises a screw anchors in blind holes in the honeycomb body.

5. The method according to claim 1 wherein the fluidic or other interface to the honeycomb body comprises an O-ring compressed against a surface on the honeycomb body by the mechanical interface.

6. A honeycomb body such as for a reactor for reacting or otherwise processing a fluid stream with a fluidic or other interface secured to the honeycomb body, the body with interface comprising:
an extruded honeycomb body;
a mechanical interface attached to the extruded honeycomb body without encircling the honeycomb body; and
a fluidic or other interface attached to the mechanical interface.

7. The honeycomb body according to claim 6 wherein the mechanical interface comprises trenches on opposing sides of the honeycomb body.

8. The honeycomb body according to claim 6 wherein the mechanical interface comprises one or more trenches on the same side of the honeycomb body.

9. The honeycomb body according to claim 6 wherein the mechanical interface comprises blind holes in the honeycomb body with screw anchors positioned in the blind holes.

10. The honeycomb body according to claim 6 wherein the fluidic or other interface, attached to the mechanical interface, further comprises an O-ring compressed against a surface on the honeycomb body by means of the mechanical interface.
